(19) United States
(12) Patent Application Publication
(10) Pub. No.: US 2014/0033428 A1
(43) Pub. Date: Feb. 6, 2014

(54) Fluidizable Bed, Method of Heat Management therefor and a Fluid Management System

(71) Applicants: Frank Sauser, Cincinnati, OH (US); Kristopher Klink, Indianapolis, IN (US); Nicole Johannigman, Greensburg, IN (US)

(72) Inventors: Frank Sauser, Cincinnati, OH (US); Kristopher Klink, Indianapolis, IN (US); Nicole Johannigman, Greensburg, IN (US)

(21) Appl. No.: 13/950,399

(22) Filed: Jul. 25, 2013

Related U.S. Application Data
(60) Provisional application No. 61/678,284, filed on Aug. 1, 2012.

(51) Int. Cl. A61G 7/057

(52) U.S. Cl. CPC A61G 7/05746
USPC 5/423

(57) ABSTRACT

A fluid management system comprises an impeller module which discharges fluid to a fluid destination, a motor module, and a coolant flowpath which services the motor module and exhausts coolant to a coolant destination different from the fluid destination. A fluidizable bed comprises impeller and motor modules, a fluidizable medium, and a fluid conditioning system. The fluid conditioning system is a fluid destination for fluid discharged from the impeller module and also conveys the discharged fluid to the fluidizable medium. A coolant flowpath for the motor module exhausts coolant to a coolant destination which differs from the fluid destination. A method of heat management comprises directing a stream of fluidizing medium to the fluidizable medium, urging a stream of coolant to flow past the motor, and proportioning the coolant stream downstream of the motor between first and second coolant destinations as a function of temperature of the fluidizable medium.

### TECHNICAL FIELD

The subject matter described herein relates to fluidizable beds, a method of heat management applicable to such beds, and to a fluid management system applicable to fluidizable and nonfluidizable beds.

### BACKGROUND

A typical fluidizable bed includes a receptacle and a porous diffuser board that divides the receptacle into a plenum and a fluidizable medium container above the plenum. A quantity of a fluidizable medium, such as tiny beads, occupies the fluidizable medium container. The quantity of fluidizable medium is sometimes referred to as a bead bath. A filter sheet overlies the bead bath. The bed also includes a blower and a fluid transfer and conditioning system (also referred to as a conditioning system or a fluid conditioning system) for conveying a fluidizing medium to the bead bath. The fluid conditioning system includes at least one heat transfer device such as one or more heaters to heat fluid flowing through the conditioning system, and one or more radiators to cool fluid flowing through the conditioning system. Typically the conditioning system includes both a heater and a radiator. A control system turns the heater and radiator on or off as necessary to control the temperature of fluid flowing through the system.

In operation a fluidizing medium such as ambient air is pressurized by the blower and propelled through the conditioning system. As the fluidizing medium flows through the conditioning system it is exposed to the heat transfer device or devices and then flows into the plenum, through pores in the diffuser board, through the bead bath and finally through pores in the the filter sheet and into the local environment. The flow of the fluidizing medium through the bead bath imparts fluid-like properties to the bead bath so that the fluidizable medium acts as a quasi-fluid. Such beds are used for burn victims or other patients who have skin disorders such as pressure ulcers or who are at high risk of developing skin disorders as a result of long term confinement in bed.

In order to promote comfort of the bed occupant a user can specify an operating temperature for the bead bath. A commonly specified operating temperature is about 93° F. (34° C.). If the temperature of the bead bath is significantly below the specified operating temperature, as would likely be the case if the bed had not been in operation for an extended time, the temperature deficit causes the control system to turn on the aforementioned heater to heat the fluidizing medium so that the fluidizing medium can quickly heat the bead bath to the specified operating temperature. The control system may also command the heater to operate if the ambient air is especially chilly. More frequently, however, the control system operates the radiator rather than the heater because the blower itself rejects a considerable amount of heat into the fluidizing medium. Unless the radiator is turned on, the fluidizing medium will heat the bead bath to a temperature higher than the specified operating temperature. For example a typical blower warms the ambient air flowing through the fluid conditioning system by about 30° F. If the ambient air is 70° F. (21° C.) the bead bath would operate at a steady state temperature of about 100° F., which is about 7° F. (4° C.) higher than the commonly specified bead bath operating temperature of 93° F. Even if the 100° F. bead bath temperature is satisfactory for the bed occupant, heat transferred from the bead bath to the ambient air will make the temperature of the local environment uncomfortably warm for caregivers and/or increase the heat load imposed on any air conditioning system used to keep the local environment cool. If the 100° bead bath temperature is unsatisfactorally warm for the bed occupant, operation of the radiator will maintain the bead bath at a more suitable temperature such as 93° F. However the radiator will reject the heat removed from the fluidizing medium into the local environment. As a result the local environment will be uncomfortably warm, just as if the heat were rejected to the local environment from the bead bath.

Accordingly, it is desirable to establish simple, cost effective methods and systems for withdrawing heat from a fluid medium supplied to a bed without rejecting that heat to the local environment. Such systems and methods may be particularly applicable when applied to the fluidizing medium used in connection with a fluidizable bed.

### SUMMARY

A fluid management system for an occupant support comprises an impeller module which discharges fluid to a fluid destination, a motor module, and a coolant flowpath configured to service the motor module and to exhaust coolant to a coolant destination that differs from the fluid destination.

A fluidizable bed comprises an impeller module including an impeller, a fluidizable medium, a fluid conditioning system downstream of the impeller module. The fluid conditioning system is a fluid destination for fluid discharged from the impeller module and is also configured to convey the discharged fluid to the fluidizable medium. The bed also includes a motor module having a motor for driving the impeller. A coolant flowpath services the motor module and exhausts coolant to a coolant destination which differs from the fluid destination.

A method of heat management for a fluidizable bed having a fluidizable medium, an air mover and a motor for powering the air mover comprises directing a stream of fluidizing medium to the fluidizable medium, urging a stream of coolant to flow past the motor, and proportioning the coolant stream downstream of the motor between a first coolant destination and a second coolant destination as a function of temperature of the fluidizable medium.

### BRIEF DESCRIPTION OF THE DRAWINGS

The foregoing and other features of the various embodiments of the bed, method of heat management and fluid management system described herein will become more apparent from the following detailed description and the accompanying drawings in which:

FIG. 1 is a schematic plan view of a fluidizable bed with a portion of its filter sheet broken away to reveal the fluidizable medium or bead bath below the filter sheet.

FIG. 2 is a side elevation view in the direction 2-2 of FIG. 1.

FIG. 3 is a schematic view showing components of a fluid conditioning system in relation to a blower assembly and in relation to the bead bath of FIGS. 1-2.

FIG. 4 is a schematic view showing components of a different fluid conditioning system in relation to a blower assembly and in relation to the bead bath of FIGS. 1-2.

FIGS. 5A-5C are views showing a blower assembly for carrying out the heat management method described herein and which is usable with a fluidizable bed, the blower assembly comprising an impeller module having a fluid intake and a fluid discharge and a motor module having a coolant inlet and a coolant outlet.

FIG. 6 is a schematic view of the blower assembly of FIG. 5, in which the coolant outlet exhausts coolant to a source of vacuum.

FIG. 7 is a schematic view similar to that of FIG. 5 but in which the coolant outlet exhausts coolant to a substantially ambient environment distinct from the local environment of the blower assembly.

FIG. 8 is a schematic view similar to that of FIG. 5 but in which the coolant outlet exhausts coolant to the local environment of the blower assembly in the vicinity of the fluid intake.

FIG. 9 is a schematic view similar to that of FIG. 5 but having a valve capable of directing coolant to a variety of destinations.

### DETAILED DESCRIPTION

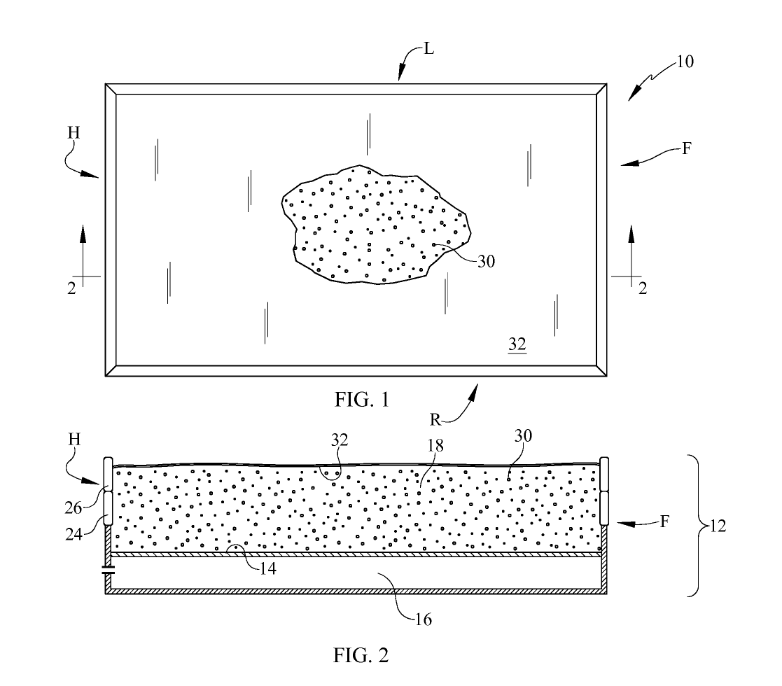

Referring to FIGS. 1-2 an occupant support such as a fluidizable bed 10 extends longitudinally from a head end H to a foot end F and laterally from a left side L to a right side R. The bed 10 comprises a receptacle 12 and a porous diffuser board 14 dividing the receptacle into a plenum 16 and a fluidizable medium container 18. The uppermost portion of the receptacle walls is shown as upper and lower air bladders 24, 26 and is sometimes referred to as an air wall. A quantity of a fluidizable medium 30 resides in container 18. The quantity of fluidizable medium is sometimes referred to as a bead bath. A porous filter sheet 32 covers the fluidizable medium.

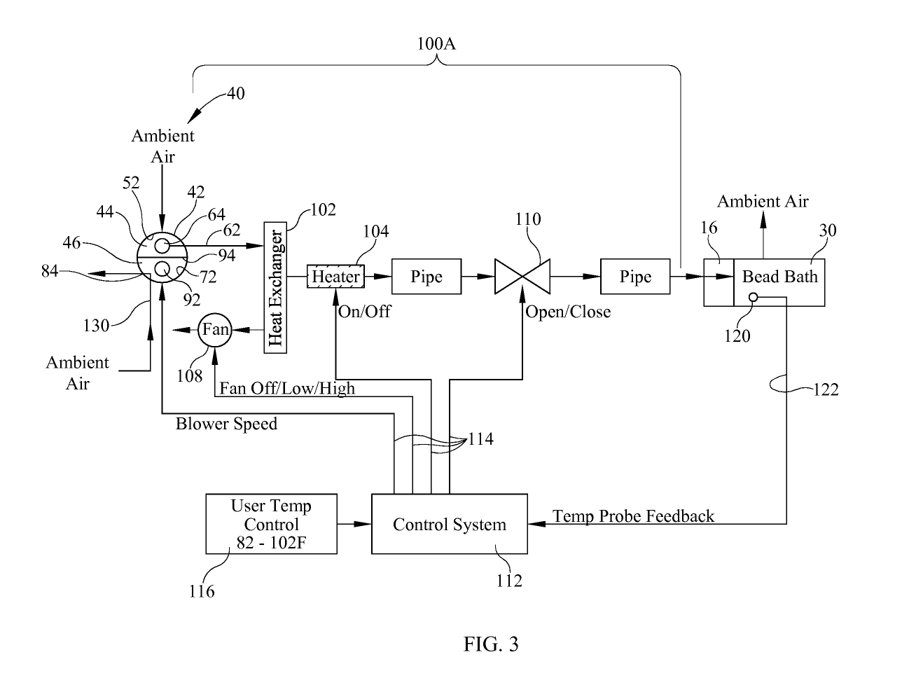

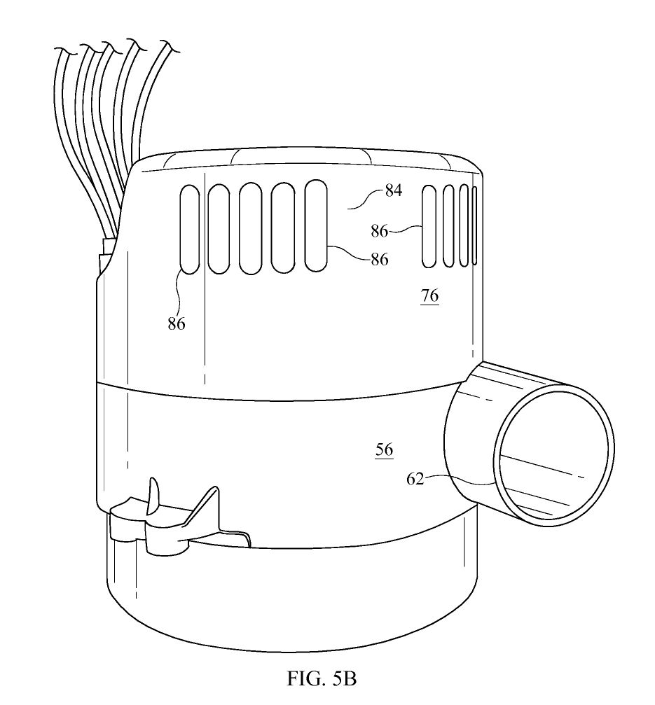

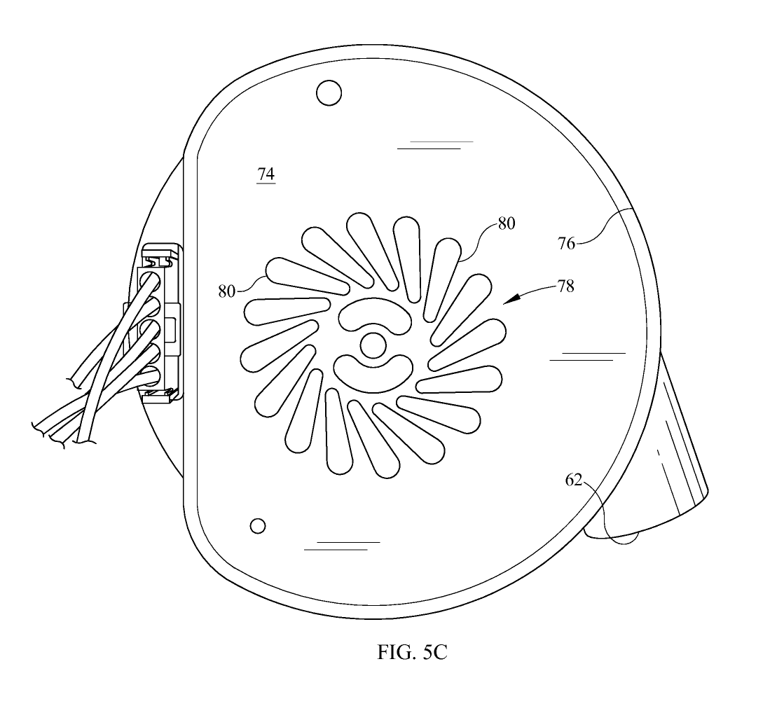

Referring additionally to FIGS. 3 and 5A-5C the bed also includes a fluid management system 40. The fluid management system includes a blower assembly 42 which comprises an impeller module 44 and a motor module 46. The impeller module includes an impeller housing 52 having an exterior end wall 54 and a circumferentially extending wall 56. An impeller fluid intake 58 penetrates end wall 54 of the impeller housing. An impeller fluid discharge 62 penetrates circumferentially extending wall 56 of the impeller housing. The impeller housing encloses an air mover such as a rotatable impeller 64. The motor module includes a motor housing 72 having an exterior end wall 74 and a circumferentially extending wall 76. A motor coolant inlet 78 defined by a series of slots 80 penetrates end wall 74 of the motor housing. A motor coolant outlet 84 defined by an array of slots 86 penetrates the circumferentially extending wall of the motor housing. The motor housing encloses an electric motor 92 which is connected to and drives the impeller. The blower assembly also has an internal partition 94 (FIG. 3) which separates the motor module from the impeller module and which exhibits some degree of thermal resistance to inhibit heat transfer from the motor module to the fluid flowing through the impeller module.

FIG. 3 shows blower assembly 42, bed plenum 16 and bead bath 30 in the context of a fluid transfer and conditioning system 100A which is also referred to as a conditioning system or a fluid conditioning system. The fluid conditioning system is downstream of impeller module 44 and upstream of the bead bath 30. The conditioning system conditions a fluidizing medium and conveys the medium to the bead bath. The conditioning system of FIG. 3 includes two heat transfer devices, specifically a radiator 102 and a heater 104, a fan 108 for drawing ambient air across the radiator, and a valve 110. As used herein, “radiator” refers to any device for encouraging heat transfer from a heat source to a heat sink. A control system 112 issues commands by way of command paths 114 to operate the blower, the fan, the heater, and the valve. A user operated temperature control 116 allows a user to specify a bead bath operating temperature. A thermocouple 120 or other temperature sensor resides in the bead bath and is responsive to the temperature of the bead bath. The control system receives a signal indicative of bead bath temperature by way of feedback path 122 and issues control signals over command paths 114 to operate the blower, radiator, heater and valve in a manner to maintain the bead bath at the operating temperature specified by the user. The illustration suggests that the feedback and command paths are physical connections such as wires or optical fibers, however the paths also represent wireless communication.

In operation ambient air serves as the fluidizing medium. The impeller draws the ambient air from the local environment by way of intake 58, pressurizes it, and propels it through impeller fluid discharge 62 to a fluid destination. The fluid destination is the fluid conditioning system 100A which appropriately conditions (heats or cools) the fluidizing medium as already described and conveys it to the bead bath.

The fluid management system also includes a coolant flowpath 130 which extends from motor coolant inlet 78 to a coolant destination by way of motor coolant outlet 84. The coolant flowpath is configured to service (i.e. cool) the motor module, specifically the motor and electronic components residing in the motor module, and to exhaust the coolant to a coolant destination outside the fluid management system and that differs from fluid destination 100A. Examples of various coolant destinations are described hereinafter. Typically, the coolant is ambient air.

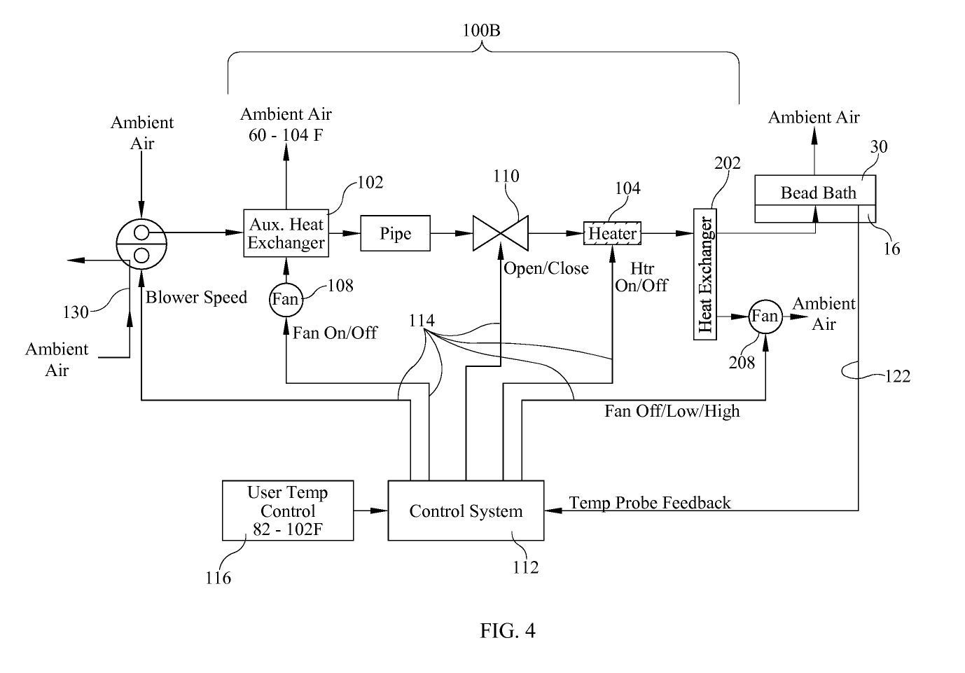

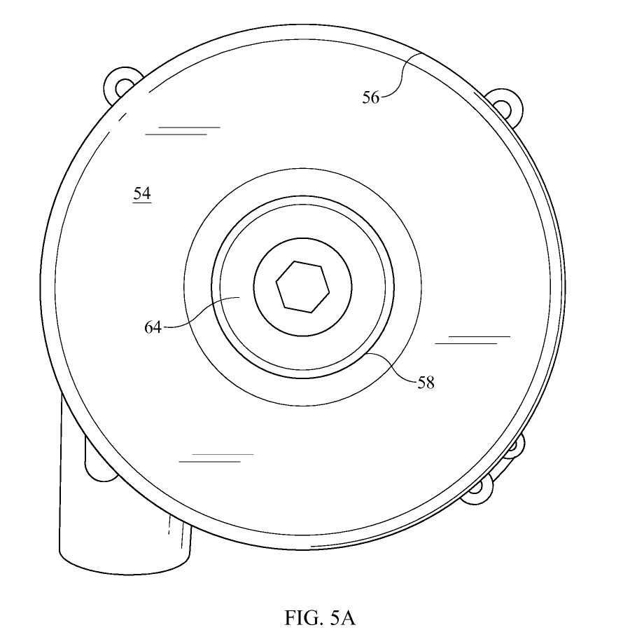

FIG. 4 shows blower assembly 42, bed plenum 16 and bead bath 30 in the context of a fluid transfer and conditioning system 100B that differs from the fluid transfer and conditioning system 100A of FIG. 3. in that the conditioning system of FIG. 4 includes two radiators 102, 202, each with a respective fan 108, 208 for urging coolant past the radiator. In addition the sequential arrangement of components differs from that of FIG. 3 as is readily evident by comparing the two illustrations. However just like the embodiment of FIG. 3, the the impeller module of the embodiment of FIG. 4 discharges fluidizing fluid to a fluid destination represented by fluid conditioning system 100B, which appropriately conditions the fluidizing medium as already described and conveys it to the bead bath. In addition coolant flowpath 130 exhausts motor module coolant to a coolant destination outside the fluid management system and different from fluid destination 102B.

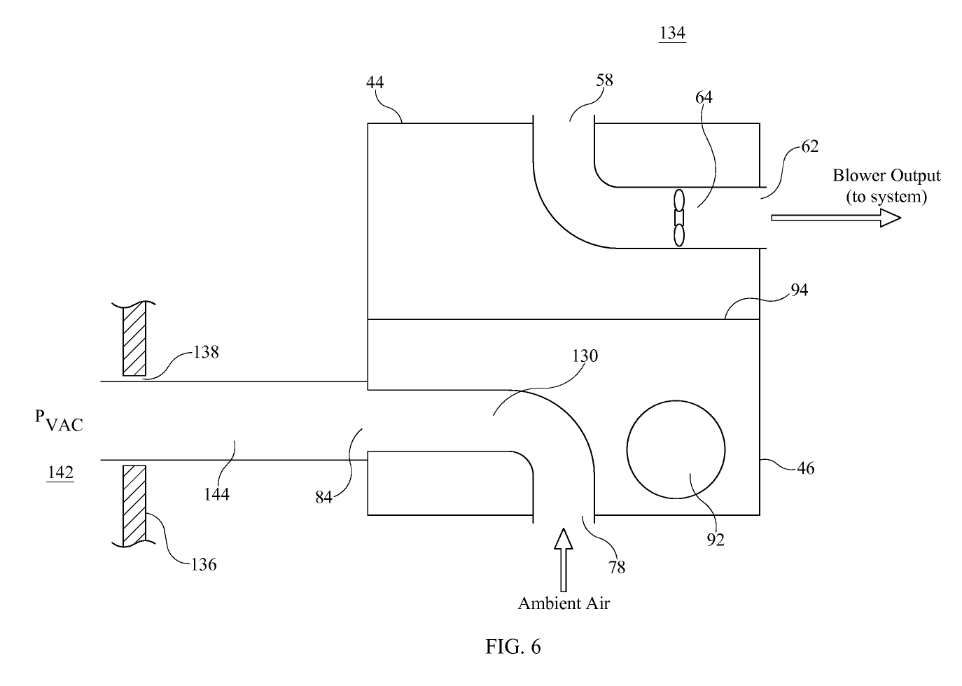

FIG. 6 shows one example of a fluid destination. In FIG. 6 a room 134 of a health care facility includes a wall 136 with a vacuum port 138 penetrating therethrough. Such vacuum ports are common features of hospital rooms, but are usually not features of home health care settings. The vacuum port is in communication with a source of vacuum 142, i.e. an environment in which the pressure is purposefully drawn down to a level lower than the ambient pressure in the room. The coolant flowpath includes duct 144 extending from motor module outlet 84 to the vacuum port. When duct 144 is connected between motor coolant outlet 84 and vacuum port 138 the vacuum source 142 serves as the coolant destination to which the coolant is exhausted.

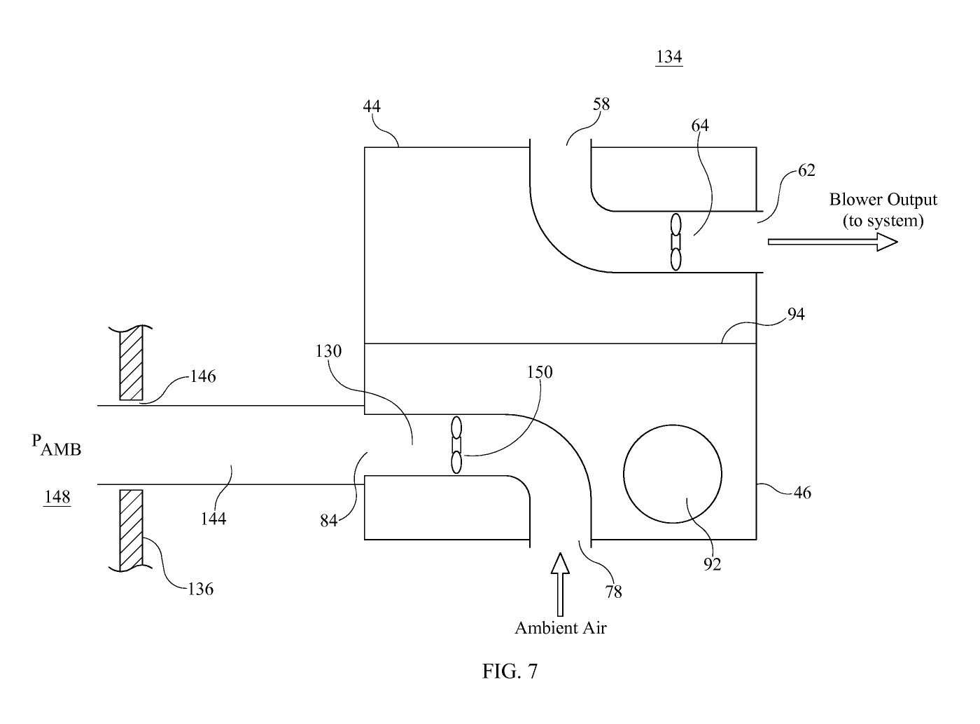

FIG. 7 shows another example of a fluid destination. In FIG. 7 a room 134 of a health care setting includes a wall 136 with a vent opening 146 penetrating therethrough. The wall separates the local environment in room 134 from environment 148 which, in contrast to the vacuum source of FIG. 6, is at substantially the same ambient pressure as room 134 but which is nevertheless distinct from local environment 134 due to the presence of wall 136. There may or may not be a temperature difference between room 134 and environment 148. Coolant flowpath 130 includes duct 144 extending from motor module outlet 84 to vent opening 146. An exhaust fan 150 resides in the coolant flowpath, for example in the portion of the coolant flowpath between inlet 78 and outlet 84 or in the portion of the coolant flowpath corresponding to duct 144. When duct 144 is connected between motor coolant outlet 84 and vent opening 146, and the exhaust fan is operated, the distinct environment 148 serves as the coolant destination to which the coolant is exhausted.

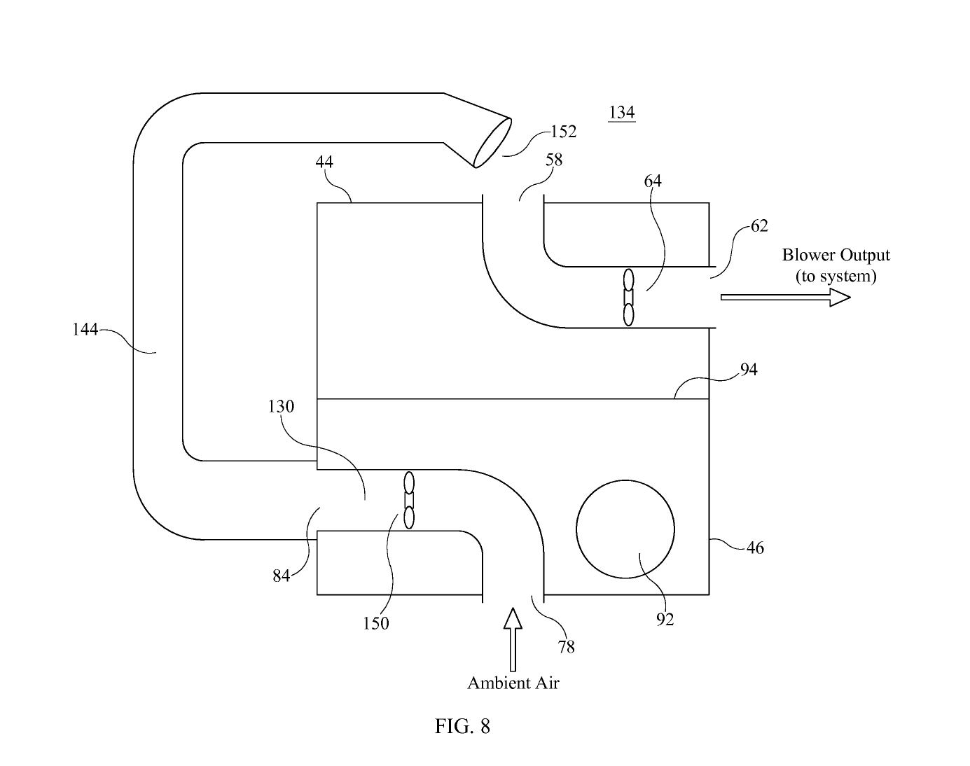

FIG. 8 shows another example of a fluid destination. In FIG. 8 the coolant flowpath includes a duct 144 extending from coolant outlet 84 to the local environment in the immediate vicinity of impeller module fluid intake 58. An exhaust fan 150 resides in the coolant flowpath, for example in the portion of the flowpath between inlet 78 and outlet 84 or in the portion of the flowpath corresponding to duct 144. When duct 144 is installed as seen in the illustration and the exhaust fan is operated, the local environment 152 in the vicinity of intake 58 serves as the coolant destination to which the coolant is exhausted. Much of the heated coolant is therefore ingested into the impeller module intake and preheats the ambient air which is concurrently drawn into the impeller. Operation in this manner may be most beneficial if the room temperature is cool or the bead bath is at unsatisfactorially low temperature and needs to be raised quickly.

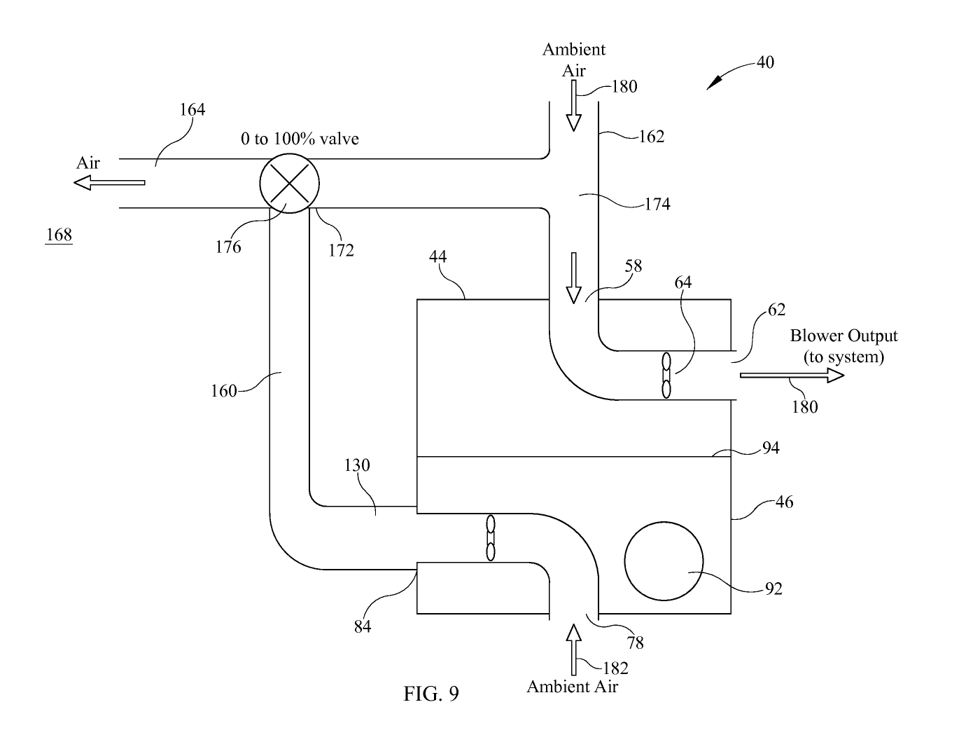

FIG. 9 shows a variant of the fluid management system which includes an exhaust duct 160 extending from outlet 84, and a distribution duct 164 extending to a remote coolant destination generically indicated by reference numeral 168 and to a local destination. An intake duct 162, which is not part of fluid management system 40, extends from impeller module intake 58. Examples of coolant destinations 168 include vacuum source 142 of FIG. 6 and the distinct ambient environment 148 of FIG. 7. Examples of the local environment include environment 152 in the immediate vicinity of intake 58 as seen in FIG. 8. Distribution duct 164 cooperates with intake and exhaust ducts 162, 160 to define outflow and inflow junctures 172, 174 A valve 176 resides at juncture 172 for exhausting coolant to different coolant destinations. Fluid (i.e. heated coolant) flowing through distribution duct 164 from valve 176 and to juncture 174 will be inevitably ingested into intake 58. Accordingly, coolant directed to or arriving at juncture 174 is considered to have been deposited in the immediate vicinity of the fluid intake, similar to the coolant issuing from duct 144 of FIG. 8, even though juncture 174 may not be physically proximate to intake 58. Alternatively intake duct 162 could be dispensed with, and the end of distribution duct 164 corresponding to juncture 174 could be positioned in the immediate vicinity of impeller intake 58 similar to the arrangement of FIG. 8.

Various types of valves 176 and corresponding operational options are envisioned. In one example valve 176 is a two position nonmodulating valve which is positionable at a recirculating position for directing substantially all of the coolant expelled from outlet 84 to the vicinity of fluid intake 58 and at an exhaust position for directing substantially all of the expelled coolant to a coolant destination 168 other than the vicinity of the fluid intake. In another example the valve is a three position nonmodulating valve positionable at the recirulating and exhaust positions just described and also positionable at a closed position. When positioned at the closed position the valve blocks fluid flow through coolant flowpath 130. As a result the fluidizing medium will be subject to greater heat transfer across internal partition 94.

In another example valve 176 is a modulating valve which is positionable not only at the recirculating and exhaust positions described above but also at intermediate positions in which the valve directs a fraction f of the coolant to the vicinity of fluid intake 58 and a fraction 1.0-f to the other destination 168. In the case of f=1.0, operation of the modulating valve corresponds to the recirculating position of the nonmodulating valve. In the case of f=0, operation of the modulating valve corresponds to the exhaust position of the nonmodulating valve. In another variant the modulating valve can also be positionable at a closed position at which it blocks fluid flow through coolant flowpath 130.

In accordance with the foregoing, a method of heat management for a fluidizable bed 10 having a fluidizable medium 30, an air mover 64 and a motor 92 for powering the air mover, will now be described. The method comprises the steps of directing a stream 180 of fluidizing medium to the fluidizable medium 30, urging a stream 182 of coolant to flow past motor 92, and proportioning the coolant stream downstream of the motor between a first coolant destination and a second coolant destination as a function of temperature of the fluidizable medium. In one example the proportioning step comprises channeling substantially all of the coolant stream to the first destination (e.g. intake 58) and substantially none of the coolant stream to the second destination (e.g. coolant destination 168) or channeling substantially none of the coolant stream to the first destination and substantially all of the coolant stream to the second destination. The proportioning step may also include an alternative of channeling substantially none of the coolant stream to either destination. In another example the proportioning step comprises channeling a fraction f of the coolant stream to the first destination and a fraction 1-f to the second destination. This fractionalized proportioning may also include an alternative of channeling substantially none of the coolant stream to either destination.

The fluid management system described herein is particularly applicable to fluidizable beds. However it may also be beneficial when used in connection with nonfluidizable beds, such as those that use pressurized air to inflate one or more supportive air bladders or in connection with toppers that use a stream of compressed air to keep an occupant cool and dry.

Although this disclosure refers to specific embodiments, it will be understood by those skilled in the art that various changes in form and detail may be made without departing from the subject matter set forth in the accompanying claims.

We claim:

1. A fluid management system for an occupant support comprising:
an impeller module having a fluid discharge for discharging fluid to a fluid destination which comprises a fluid conditioning system that includes at least one heat transfer device;
a motor module; and
a coolant flowpath configured to service the motor module and to exhaust coolant to a coolant destination that differs from the fluid destination.

2. The fluid management system of claim 1 in which the coolant destination is a vacuum source.

3. The fluid management system of claim 1 in which the coolant destination is a substantially ambient environment distinct from a local environment of the fluid management system.

4. The fluid management system of claim 1 in which the impeller module includes a fluid intake and the coolant destination is a local environment of the fluid management system in the vicinity of the fluid intake.

5. The fluid management system of claim 1 in which the coolant flowpath includes a valve for exhausting coolant to different coolant destinations.

6. The fluid management system of claim 5 in which the valve is positionable at a recirculating position for directing substantially all of the coolant to the vicinity of the fluid intake and at an exhaust position for directing substantially all of the exhausted coolant to a coolant destination other than the vicinity of the fluid intake.

7. The fluid management system of claim 6 in which the valve is also positionable at a closed position.

8. The fluid management system of claim 5 in which the valve is also positionable at intermediate positions for directing a fraction f of the coolant to the vicinity of the fluid intake and a fraction 1-f to the other destination.

9. The fluid management system of claim 8 in which the valve is also positionable at a closed position.

10. The fluid management system of claim 6 in which the valve is also positionable at intermediate positions for directing a fraction f of the coolant to the vicinity of the fluid intake and a fraction 1-f to the other destination.

11. The fluid management system of claim 10 in which the valve is also positionable at a closed position.

12. The fluid management system of claim 1 in which the motor module and the impeller module are components of a blower assembly and in which the motor module drives an impeller of the impeller assembly.

13. A fluidizable bed comprising:
an impeller module including an impeller;
a fluidizable medium;
a fluid conditioning system downstream of the impeller module, the fluid conditioning system being a fluid destination for fluid discharged from the impeller module and also configured to convey the discharged fluid to the fluidizable medium;
a motor module having a motor for driving the impeller; and
a coolant flowpath configured to service the motor module and to exhaust coolant to a coolant destination that differs from the fluid destination.

14. The fluidizable bed of claim 13 wherein the coolant destination is outside the fluid management system.

15. The fluidizable bed of claim 13 wherein the fluid conditioning system includes at least one heat transfer device.

16. The fluidizable bed of claim 13 in which the coolant destination is a vacuum source.

17. The fluidizable bed of claim 13 in which the coolant destination is a substantially ambient environment distinct from a local environment of the fluid management system.

18. The fluidizable bed of claim 13 in which the impeller module includes a fluid intake and the coolant destination is a local environment of the impeller module in the vicinity of the fluid intake.

19. The fluidizable bed of claim 13 in which the coolant flowpath includes a valve for exhausting coolant to different coolant destinations.

20. The fluidizable bed of claim 19 in which the valve is positionable at a recirculating position for directing substantially all of the coolant to the vicinity of the fluid intake and at an exhaust position for directing substantially all of the exhausted coolant to a coolant destination other than the vicinity of the fluid intake.

21. The fluidizable bed of claim 20 in which the valve is also positionable at a closed position.

22. The fluidizable bed of claim 20 in which the valve is also positionable at intermediate positions for directing a fraction f of the coolant to the vicinity of the fluid intake and a fraction 1-f to the other destination.

23. The fluidizable bed of claim 22 in which the valve is also positionable at a closed position.

24. The fluidizable bed of claim 13 in which the motor module and the impeller module are components of a blower assembly and in which the motor module drives an impeller of the impeller assembly.

25. A method of heat management for a fluidizable bed having a fluidizable medium, an air mover and a motor for powering the air mover, the method comprising:
directing a stream of fluidizing medium to the fluidizable medium;
urging a stream of coolant to flow past the motor;
proportioning the coolant stream downstream of the motor between a first coolant destination and a second coolant destination as a function of temperature of the fluidizable medium.

26. The method of claim 25 in which the proportioning step comprises:
a) channeling substantially all of the coolant stream to the first destination and substantially none of the coolant stream to the second destination or
b) channeling substantially none of the coolant stream to the first destination and substantially all of the coolant stream to the second destination.

27. The method of claim 26 in which the proportioning step includes an alternative of channeling substantially none of the coolant stream to either destination.

28. The method of claim 25 in which the proportioning step comprises channeling a fraction f of the coolant stream to the first destination and a fraction 1-f to the second destination.

29. The method of claim 28 in which the proportioning step includes an alternative of channeling substantially none of the coolant stream to either destination.
